(19) United States
(12) Patent Application Publication
(10) Pub. No.: US 2002/0099672 A1
(43) Pub. Date: Jul. 25, 2002

(54) Fuzzy logic based processing system and method with uncertain input

(76) Inventor: Chidambar Ganesh, Bristol, RI (US)

Correspondence Address: Office Of Counsel, Bldg 112T, Naval Undersea Warfare Center, Division, Newport, 1176 Howell Street, Newport, RI, 02841-1708, US

(21) Appl. No.: 09/932,567

(22) Filed: Aug. 17, 2001

Related U.S. Application Data
(63) Continuation-in-part of application No. 09/246,208, filed on Jan. 20, 1999.

(51) Int. Cl. G06F 15/18

(52) U.S. Cl. 706/1

(57) ABSTRACT

A fuzzy inference system and method are disclosed that may be used not only with known or definite data input but also with uncertain data input. The uncertain data input may be represented by a set of values wherein the possibility of any particular or specific value within the set being the true or accurate value is uncertain. A set of rules are provided within a rule decomposer that are used to produce a plurality of mappings such as a plurality of one dimensional solutions. A union operator is utilized for determining a conjunction of the plurality of mappings such as the plurality of one dimensional solutions. The system output may then be used for control purposes such as, for example only, a combat control system to provide a tactical picture, decision assist, presets for a guidance system, or the like.

The present invention is a continuation-in-part of U.S. Application Ser. No. 09/246,208, filed Jan. 20, 1999.

### STATEMENT OF THE GOVERNMENT INTEREST

The invention described herein may be manufactured and used by or for the Government of the United States of America for Governmental purposes without the payment of any royalties thereon or therefore.

### BACKGROUND OF THE INVENTION

(1) Field of the Invention

The present invention relates generally to decision support systems based on fuzzy logic and, more specifically, to a fuzzy logic information processing system such as a control system and method capable of handling uncertainty in the input data with improved computational efficiency.

(2) Description of the Prior Art

Other than my previous patent application referenced above, traditional fuzzy logic systems do not have the ability to process inexact input data e.g., measurements that are imprecise, or information that has attendant uncertainty. My previous patent application teaches (i) an enhanced fuzzy system and (ii) a novel inferencing method for handling input data uncertainty in a fuzzy logic framework. While the embodiment of a fuzzy logic information processing system disclosed in my previous patent application does handle inexact input data, some usages thereof may be computationally demanding, and may sometimes be impractical for systems of high dimension (3 or greater).

Except as taught in my previous application referenced above, methods for data integration and decision support in submarine combat systems do not adequately account for uncertainty in the input data in an automated fashion. Instead they rely heavily on operator manipulation and human interpretation.

Combat system information processing entails the integration of data from diverse sources for tactical picture generation and maintenance, situation assessment and planning, and allocation/control of resources. On the other hand, in many systems the amount and flow of input data for integration has been rapidly increasing in recent years. Thus, the cost of more human operators for manning purposes is also rapidly increasing. It is anticipated that advances in sensor technology will continue to offer more possibilities in gathering related both acoustic and non-acoustic streams from organic as well as off-board sources, environmental and kinematic descriptors, intelligence reports and sensor characteristics. The combat system of the future therefore requires the ability to automatically manage uncertainty in areas such as uncertain data input. Uncertainty management for handling uncertainty in the input data remains an outstanding technical issue and constitutes a significant Navy problem as well as a scientific and industrial challenge.

Uncertainty refers to being in a condition of doubt. The is contrasted to a condition of certainty or being definite, known, or specific. In an information processing context, uncertainty can be thought of as having a lack of definitive knowledge necessary to describe the process. Uncertainty in the input may result due to many causes including but certainly not limited to sensor noise, gaps in sensor information, sensor bias, inadequate number or placement of sensors, transmission noise or limitations, “one-time only” availability, and the like. While most signals are measured within a tolerance, e.g., ten volts plus or minus one hundred micro volts, an uncertain signal is not known within the normal tolerances and may be so uncertain that normally used sensor tolerances are meaningless. Thus, while a tolerance of one hundred micro volts might be an accepted tolerance for an accurate signal in a particular application, an uncertain signal might vary by several volts or by more than one thousand times the normal accepted tolerance for the signal thus making the signal quite uncertain in a particular application. Thus, a known or definite signal might be 10 volts, an uncertain signal might be representable only as a possible value between 8 and 12 volts. As another example of uncertain input, a sonar system working in a multipath environment may send out a sonar pulse and receive two or three sonar pulses in return. All three sonar pulses may be received within a time frame that would present reasonable distance/direction information for receipt from the intended target. Therefore, there is uncertainty associated with each returned sonar pulse. As another example, it may be possible to get an uncertain value immediately where a decision for action may need to be taken now where in time a more certain value will be available. This situation may typically arise in a target motion analysis where a fundamental property of bearings-only target motion analysis is that contact range is not observable for a single-leg ownship motion wherein a leg is defined as a time interval of constant platform velocity. The range becomes observable only after an ownship maneuver followed by a second leg of motion that therefore introduces a time-latency in the estimation process owing to the necessity of collecting sufficient data on all legs of motion. Thus, there are many different scenarios of types of uncertainty that will depend on each different situation.

As a general matter, an information processing system such as a combat control system or other typical control system will produce one or more specific or definite control signals in response to the input data. A representative example might include a tactical picture display that might show a submarine in relation to other targets. Another example might include a control for a motor to adjust rudder position. This is also true of a fuzzy logic-based control system. Fuzzy logic control systems have been employed successfully employed in various applications. Moreover, fuzzy logic controllers have been successfully applied and demonstrated in underwater combat control systems such as, for example, a conditioned fuzzy logic controller for an acoustic vehicle intercept guidance system.

A prior art fuzzy inference system has three basic components. The fuzzifier converts discrete or crisp input numbers to fuzzy logic membership values that describe a qualitative description of the discrete input in semantic terms. For instance, a numerical sensor value such as might be produced from a sensor voltage might be converted from its discrete, known, or specific value to a fuzzy logic member ship value that is more qualitative, e.g., low, medium, or high. The output of the fuzzifier is represented in the membership values, and comprises the fuzzy logic input membership values. The fuzzifier is not designed to handle an input that is inexact and/or which has a possibility of varying throughout a range of values. Traditional usage of this structure has been in control systems applications, where errors in the input are typically ignored. The ill-effects of any error are (hopefully) mitigated by a rapid update-rate; i.e., new measurements or updated information are provided in a time-frame that is short compared to the dynamics of the system to be controlled. Uncertain input data is a problem in data integration and decision support applications (such as submarine combat control) where the measurements have a very slow update-rate or the information is of ‘one-time’ only availability.

The input membership values are used by an inference engine. The inference engine creates a knowledge base from rules that permit an inference and subsequent aggregation of all the output membership functions from the rules that are triggered by the fuzzy logic input membership values. Thus, the inference engine maps the fuzzy logic input membership values to a single fuzzy output set based on applicable rules from the knowledge base.

The defuzzifier converts the fuzzy output set to a crisp, discrete, particular output value for subsequent usage, e.g., the controller output in a feedback system. That is, given an exact number x=a as input, the output is an exact number V=b. The crisp output is representative of the fuzzy output set and might be analogous to the expected value in a probability distribution.

In summary, a conventional fuzzy system does not have the mechanism to handle an uncertain input, yet such inputs are typically encountered in practice, e.g., data integration for submarine combat control. Simply taking an average, making an estimate, or calculating a normal value and using the discrete value so determined as input to the fuzzy logic inference system will limit the information that is available about the uncertainties, and thereby reduce the likelihood of making the best possible decision.

Patents that show attempts to solve the above and other problems are as follows:

U.S. Pat. No. 5,926,802, issued Jul. 20, 1999, to Manfred Menke, discloses a method in which several rules having an identical conditional part and different consequence parts are processed more quickly in that the fuzzification and at least parts of the inference formation are carried out only once, and in which the storage capacity of a knowledge base memory can be reduced, since all identical conditional parts need be stored only once.

U.S. Pat. No. 5,809,486, issued Sep. 15, 1998, to Antonino Cuce, discloses an invention that relates to a fuzzy processor having an input X for at least a plurality of input variables X-i and an output U for one or more output results U-k, and including a fuzzyfication unit FU having an input coupled to the input X, a fuzzy rule processing unit RU having an input coupled to the output of the fuzzyfication unit FU, and a defuzzyfication unit DU having an input coupled to the output of the processing unit CU and an output coupled to said output U, wherein the output of the defuzzyfication unit DU is coupled to the input of the fuzzyfication unit FU and/or to the input of the processing unit RU.

U.S. Pat. No. 5,710,867, issued Jan. 20, 1998, to Giacalone et al., discloses a method and system for processing a plurality of fuzzy logic rules. The system includes a plurality of fuzzy logic lines, each fuzzy logic line corresponding to one of the fuzzy logic rules and including a calculating device. Each calculating device has an input terminal for receiving a series of weights and an output terminal for outputting an overall truth value according to the received series of weights and at least one logical operator of the fuzzy logic rule corresponding to the fuzzy logic line. The system further includes processing circuitry coupled to each fuzzy logic line, for receiving the overall truth value from each line, and outputting a fuzzy logic value according to the received overall truth values.

U.S. Pat. No. 5,677,996, issued Oct. 14, 1997, to Lee et al., discloses a fuzzy computer which provides high speed fuzzy processing by executing fuzzy information processing in parallel. The fuzzy computer operates according to programs and data downloaded from a host system, and executes fuzzy information processing in parallel to process this information at high speed. The fuzzy computer comprises a single fuzzy processing controller which downloads and designates to control memory operational programs from the host system, starts fuzzy operations according to signals inputted to an instruction register, and informs the host system of its processing status through a status register. A plurality of fuzzy processing elements are connected in parallel to the single fuzzy processing controller through system buses, download fuzzy data from the host system to each built-in knowledge base and perform respective functions in parallel according to control signals from the single fuzzy processing controller.

U.S. Pat. No. 5,579,439, issued Nov. 26, 1996, to Emdadur R. Khan, discloses a fuzzy logic design generator for providing a fuzzy logic design for an intelligent controller in a plant control system, including an artificial neural network for generating fuzzy logic rules and membership functions data. These fuzzy logic rules and membership functions data can be stored for use in a fuzzy logic system for neural network based fuzzy antecedent processing, rule evaluation and defuzzification, thereby avoiding heuristics associated with conventional fuzzy logic algorithms. The neural network, used as a fuzzy rule generator to generate fuzzy logic rules and membership functions for the system's plant controller, is a multilayered feed-forward neural network based upon a modified version of a back-propagation neural network and learns the system behavior in accordance with input and output data and then maps the acquired knowledge into a new non-heuristic fuzzy logic system. Interlayer weights of the neural network are mapped into fuzzy logic rules and membership functions. Antecedent processing is performed according to a weighted product of the antecedents. One layer of the neural network is used for performing rule evaluation and defuzzification. However, invention is still conventional in the sense that the inputs need to be exactly specified. U.S. Pat. No. 5,524,179, issued Jun. 4, 1996, to Masae Kanda, discloses a fuzzy inference apparatus based on fuzzy rules represented by an if-then notation, comprising a CPU having a software for obtaining grades of if-part membership functions with respect to input variables for each rule and a hardware for obtaining a truth value of the if-part of each rule, a truth value of the then-part of each rule, and an inference result. The hardware comprises a predetermined number of then-part membership function calculators for respectively storing the then-part membership functions defined in the then-part of the rules, minimum calculators respectively connected to the then-part membership function calculators, and a maximum calculation circuit connected to all the then-part membership function calculators. The CPU supplies the grades of the if-part membership functions for each rule to one of the minimum calculators which is connected to the then-part membership function calculator storing the then-part membership function defined in the then-part of the rule. The CPU outputs a predetermined number of grade regardless of the number of the input variables defined in the rule. The grade of the membership function is set to 1 where the input variable is not defined in the rule. However, this invention suffers from the basic limitation of conventional fuzzy system in that the input variables need to be precisely specified. There is no mechanism to process inexact input data, e.g., measurements that are imprecise or information with attendant uncertainty.

A publication, the Naval Undersea Warfare Center Division Newport, Newport R.I., NUWC-NPT Technical Report 10,876, dated Jan. 20, 1998, entitled “Fuzzy Logic-Based Inferencing in the Presence of Input Data Uncertainty,” authored by Chidambar Ganesh, describes the use of a fuzzy inference machine to take an input which includes uncertain data item(s) and provides fuzzy inference output which represents this uncertainty. However, the computation process which the publication teaches are very numerically intensive and require very large amounts of dynamic random access memory (RAM) storage associated with a processor.

In view of the above-cited prior art which does not show how to handle uncertain data, there remains a need for a fuzzy logic-based information processing system that can not only handle uncertain input but do so with improved computational efficiency. Those skilled in the art will appreciate the present invention that addresses the above and other problems.

### SUMMARY OF THE INVENTION

Accordingly, it is an object of the present invention to provide an improved system and method for processing data using fuzzy logic with increased computational efficiency.

It is another object of the present invention to provide such an improved fuzzy logic system that is capable of processing either certain or uncertain data.

It is yet another object of the present invention to provide an improved fuzzy logic-based control system and method.

It is yet another object of the present invention to provide an improved fuzzy logic-based tactical picture and decision support system.

These and other objects, features, and advantages of the present invention will become apparent from the drawings, the descriptions given herein, and the appended claims.

In accordance with the present invention, a fuzzy inference system for processing information including uncertain information is disclosed. At least one input provides information that is indicative of one or more physical phenomena. The input is representable by an input set that describes a range of possible values related to the one or more physical phenomena. When a precise value for the input is not available such that the input value is uncertain, then an input data set is representable mathematically by a first map of possible values related to the one or more physical phenomena.

The fuzzy inference system may comprise elements, such as for instance, a rule decomposer that preferably includes a plurality of rules. Each of the rules may be utilized for producing an output in response to the plurality of inputs to thereby produce a plurality of rule decomposer outputs. Other elements may include a union operator for determining an intersection of the plurality of rule decomposer outputs to produce an fuzzy inference system output.

In one presently preferred embodiment, each of the plurality of rules may be of an IF-THEN format. The fuzzy inference system output signal may be used as a control signal.

In one embodiment, a dynamic RAM storage may be utilized for storing precomputed outputs of the rule decomposer.

In another embodiment, the system may provide a system control signal, and in yet another embodiment it may provide a tactical picture.

A method in accord with the present invention for a fuzzy inference system that utilizes uncertain input data may comprise steps such as providing a plurality of rules, producing a plurality of rule outputs in response to the uncertain input data, and inferring an output of the fuzzy inference system by determining a conjunction of the plurality of rule outputs.

Other steps may include operating on the input set of possible values to produce a rule output for each of the plurality of rules and/or precalculating a rule output. If precalculations are made, then a preferred embodiment may include storing a result of the step of precalculating in RAM memory. In one embodiment the method may comprise producing a tactical picture that incorporates the output from the fuzzy inference system. Another method for a fuzzy inference system in accord with the present invention for utilizing uncertain input data that has an uncertain value contained within an input set of possible values such that the uncertain input data may be associated with one or more physical phenomena, may comprise steps such as, for instance, producing a plurality of one dimensional solutions in response to the uncertain input data, and inferring an output of the fuzzy inference system by determining a conjunction of the one dimensional solutions.

The method may further comprise producing the plurality of one dimensional solutions from a plurality of rules. Moreover, the method may comprise producing a respective one dimensional solution from a respective rule.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings wherein corresponding reference characters indicate corresponding parts throughout several views of the drawings and wherein:

FIG. 1 is a block diagram of an embodiment of a fuzzy logic system capable of processing either certain or uncertain data which is precursory of the fuzzy inference system architecture of FIG. 10;

FIG. 2 is a block diagram of a fuzzy logic inference system as might be used in the fuzzy logic information processing system of FIG. 1;

FIG. 3 is a mathematical representation of the data that is illustrative of data operated upon by the inference system of FIG. 2, and that is uncertain wherein it is known only that the actual value is within the shaded region;

FIG. 4 is map illustrative of rules involved in the operation of the inference system of FIG. 2:

FIG. 5 is an arbitrary graph descriptive of a bell or Gaussian curve illustrative of a set of possible values for the input for which any particular value in the set is uncertain, which may be involved in the operation of the inference system of FIG. 2;

FIG. 6 is a map of the uncertain data of FIG. 5 that has been extended into another dimension by an extensor or cylindrical extensor in accord with the present invention:

FIG. 7 is a map of the combination of the map of FIG. 5 and the map of FIG. 6;

FIG. 8 is an output for the information processing system of FIG. 1 that shows the output in the desired terms and also compares a fixed value input with the results of an uncertain input;

FIG. 9 discloses one of many possible tactical displays in which the output of the information processing system of FIG. 1 may be used; and

FIG. 10 depicts a fuzzy inference system architecture with improved computational capabilities based on a rule decomposition in accord with the present invention.

### DESCRIPTION OF THE PREFERRED EMBODIMENTS

While the invention described in my previous patent application referenced hereinbefore is capable of using inexact input data, the computation can be very numerically intensive, and is an exponential function of the number of inputs and the grid-resolution employed.

There is first hereinafter provided, with reference to FIGS. 1-9, a description of the embodiment of fuzzy logic processing system disclosed in my previous patent application. There is then provided, with reference to FIG. 10, a description of a fuzzy inference system architecture based upon Rule Decomposition in accordance with the present invention, which is less numerically intensive, with the numerical intensity only growing as a linear function of such inputs and grid-resolutions.

Referring now to the drawings and more specifically to FIG. 1, a fuzzy logic processing system 10 detects stimulus 11, and the latter's characteristics are relayed to output 36, which uses fuzzy logic when uncertainties related to stimulus 11 and/or other aspects of the input exist. Thus, the problem involves uncertainties that propagate through system 10. Stimulus 11, which may be one or more physical phenomena of some type such as propeller rotation frequency or pattern and may produce one or more of signals 12, 14 and 16. One or more of a signals 12, 14, and 16 are received by remote organic sensor 18, organic sensor 20, and/or off board sensor 22, respectively. Signals 12, 14 and 16 could be descriptive or related to a natural physical phenomena such as color or a reflection of some kind like radar or sonar. Remote organic sensor 18 and organic sensor 20 use in this case the definition of organic as being associated with the body or craft that the sensors are either attached to or are in control of. Organic sensors can therefore include a remotely launched probe, sonar, radar, or any type of device which detects physical phenomena such as, for instance, detection of another object for tracking purposes. Off board sensor 22 is independent of the body or craft and can transmit the data relating to stimulus 11 which, as discussed above, may represent numerous different types of stimuli. The data collected by sensors 18, 20 and/or 22 are transmitted through respective possible transmission paths 24, 26 and 28. These paths may have physical imperfections which can cause gaps in the data, as depicted by uncertainty 30. Uncertainty 30 could arise in many ways and at many places in the processing system and is pictured in a specific place only for convenience. For instance, sensors 18, 20 and 22 may not have detected all signals or have received erroneous information, thus more uncertainty is present. There may be a time lag problem as discussed subsequently. It will be understood by those skilled in the art that there are virtually an infinite number of reasons that can arise to cause uncertainty within the input data. Thus, the result is that data with inherent uncertainties is received by fuzzy inference system 32 from one or more of signal paths 24, 26, and/or 28. While prior art fuzzy inference systems cannot handle uncertain data, the inference system of my previous patent application can handle uncertain or certain data, as explained in more detail hereinafter, using rules 34 within fuzzy inference system 32 to yield output 36, that may be used for producing a tactical picture, guidance presets, motor control, decision support, and the like.

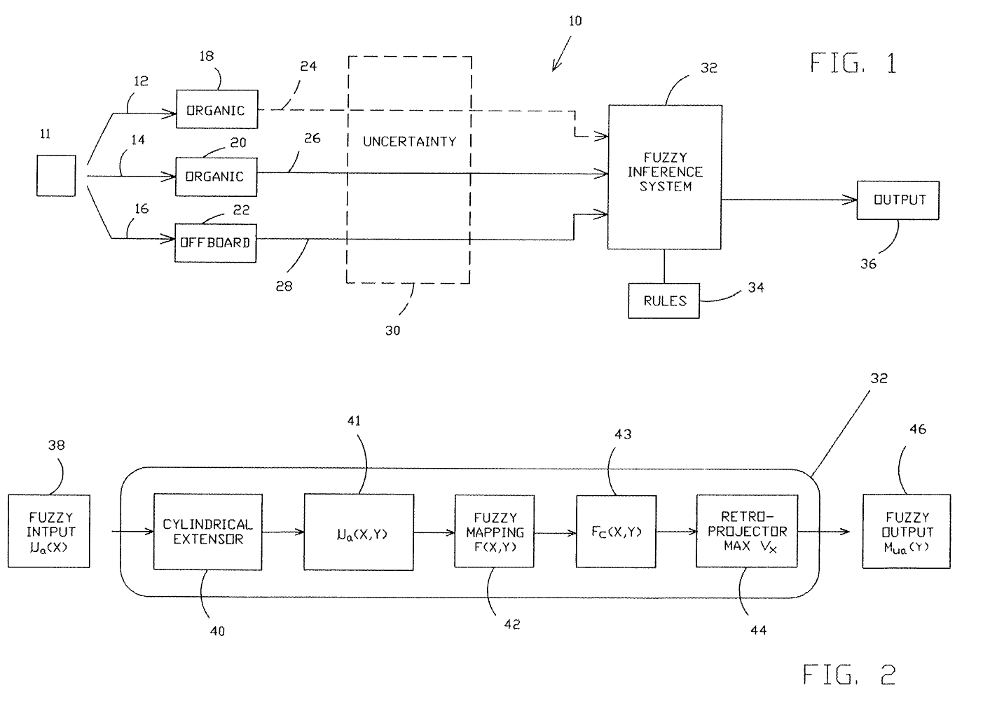

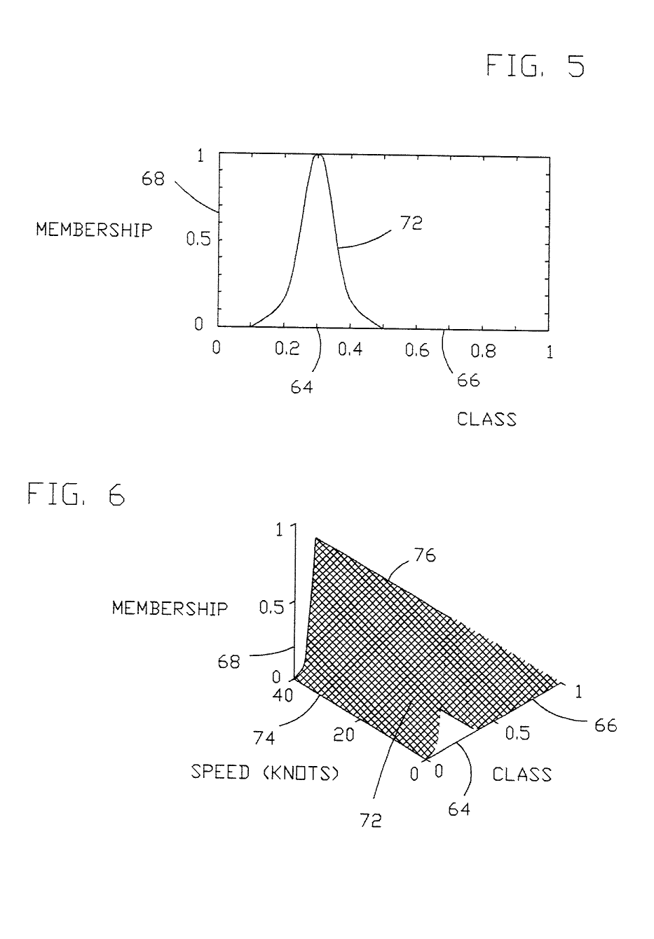

The fuzzy inference system 32 disclosed in my previous patent application is shown in greater detail in FIG. 2. The collective data sent over paths 24, 26 and/or 28 detected by sensors 18, 20 and 22 contains uncertainty as represented graphically by the region of fuzzy input 38 wherein it is uncertain what the precise value of fuzzy input 38 is. Fuzzy input 38 is mathematically represented by μₐ (x), with collective data that varies about the line x=a. Thus, whereas the prior art fuzzy inference systems would require a precise input, such as x=a, system 32 can handle the uncertain input where it is known only that input x varies about a to form a set of possible values described by the function μₐ (X). The region or set of values described by μₐ (x) is arbitrarily selected in the present example and could take on many different forms or shapes. For the present explanation purposes, a Gaussian bell type curve distribution describes the region of possible values for the input as shown by FIG. 5. The input could be in the form of a square wave, pulse, multiple sections, or other shapes. While the example given herein uses a numerical characterization of uncertain data, it will be understood that the present invention is not limited to numerical characterization and could also be used with other types of symbolic characterizations of data as might be used for the particular problem to be solved.

Fuzzy input 38 is received by fuzzy inference system 32 and operated on by extensor or cylindrical extensor 40. Cylindrical extensor 40, in the present example, operates on fuzzy input 38 to provide an extension of fuzzy input 38 in the x, y plane to form extension 41, as represented by

μₐ(x,y)=μₐ(x)∀y. (1)

Extension 41 might be graphically described as adding an extra dimension or, in this case, a third dimension. However, it will be understood that depending on the complexity of the problem many dimensions may be involved so that a visually understandable picture of an extended bell curve as might be in exemplified by FIG. 6 may not always be available for every problem. The modified data or extension 41 is made available for fuzzy mapping section 42 for further operation. Fuzzy section 42 is derived from rules 34 and is mathematically represented by F(x,y). Fuzzy mapping section 42 operates on extension 41 to yet again amend the data to form the conditioned data or surface 43 or F_{c}(x,y) which might be visualized as shown in FIG. 7. The whole operation performed by fuzzy mapping 42 can be described as

F_{c}(x,y)=min [F(x,y), μₐ(x,y)]. (2)

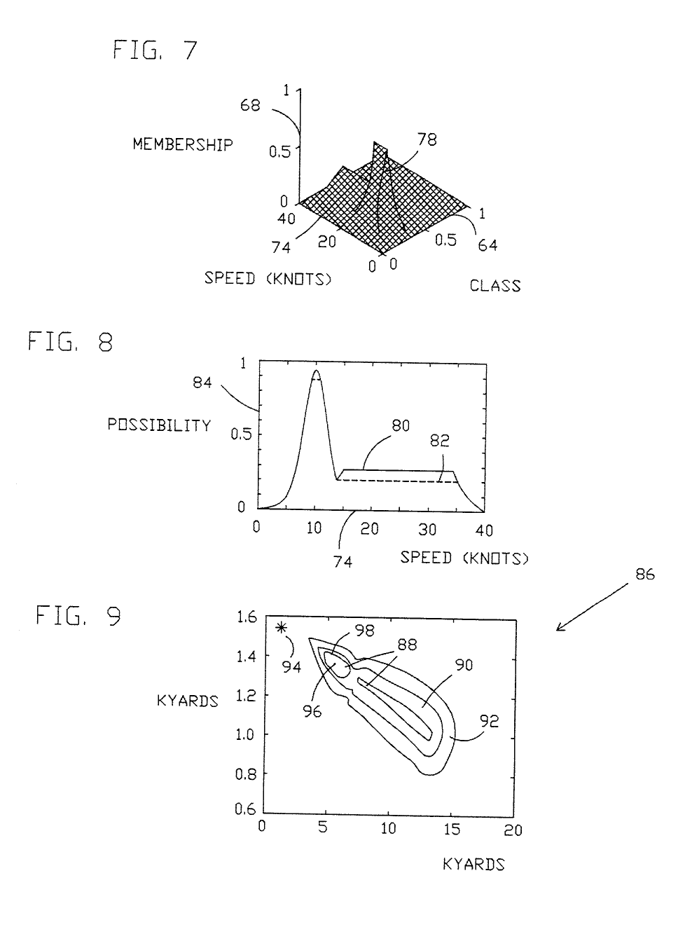

In the example of the present case, this can be verbally, symbolically, or linguistically restated as the graphical intersections of rules 34 and the output of cylindrical extensor 40 to form conditioned surface 43. Now retro-projector 44 receives the F_{c}(x,y) or conditioned surface 43 and transforms it into fuzzy output 46 or M_{μa}(y) as might be graphically represented as shown in FIG. 8. This process can be symbolized by the formula

M_{μa}(y)=max_{∀x}[F_{c}(x,y)]. (3)

The process of the above equation may be visually or graphically described as projecting the data output from fuzzy mapping 42 onto the y plane, resulting again in two dimensional data having the desired output units as shown, for example in FIG. 8.

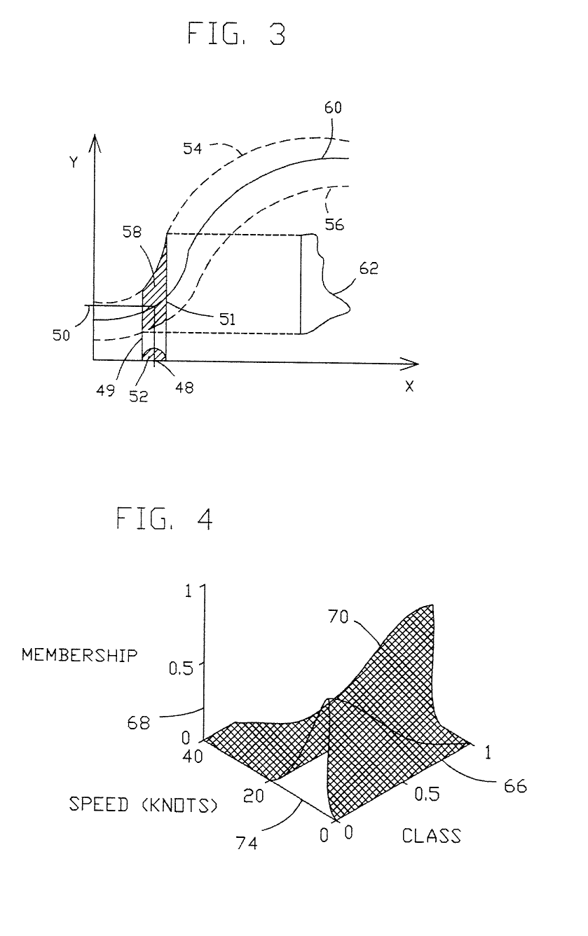

FIG. 3 provides an example that graphically depicts the operation of fuzzy inference system 32 in a particular case as discussed below. Point 48 represents the value x=a, an exact value. While a prior art fuzzy logic inference system would require such an exact value, a crisp input value is not known in the present example so that shaded region 52 generalizes x as being in that area, defined by the function μₐ (x). Had x=a been known, point 50 would represent y=b, an exact value as might be described using a prior art fuzzy logic inference system. The cylindrical extensor extends the function Da(x) into another dimension with

μₐ(x,y)=μₐ(x)∀y, (4)

as discussed above. The input data now is uncertain but the set of possible values has the form μₐ(x,y) represented by the area between lines 49 and 51. The rules are graphically described as the value between lines 54 and 56 and represented by F(x,y). Shaded region 58 is generated by the cylindrical extensor output and the rules to form, represented by F_{c}(x,y). In other words, the area defined by lines 49, 51, 54 and 56. Mathematically, F_{c}(x,y)=F(x,y) ^{o}μ(x,y), with ^{o} being a fuzzy composition go operation. In comparison, had exact values been known as required in a prior art fuzzy logic inference system, line 50 would accurately depict this output. Finally, the data is transformed back into usable form by projecting the graphical image into the desired units by removing a dimension, represented by line 62. This is the fuzzy output M_{μa}(y), given by

M_{μa}(y)=max_{∀x}[F_{c}(x,y)]. (5)

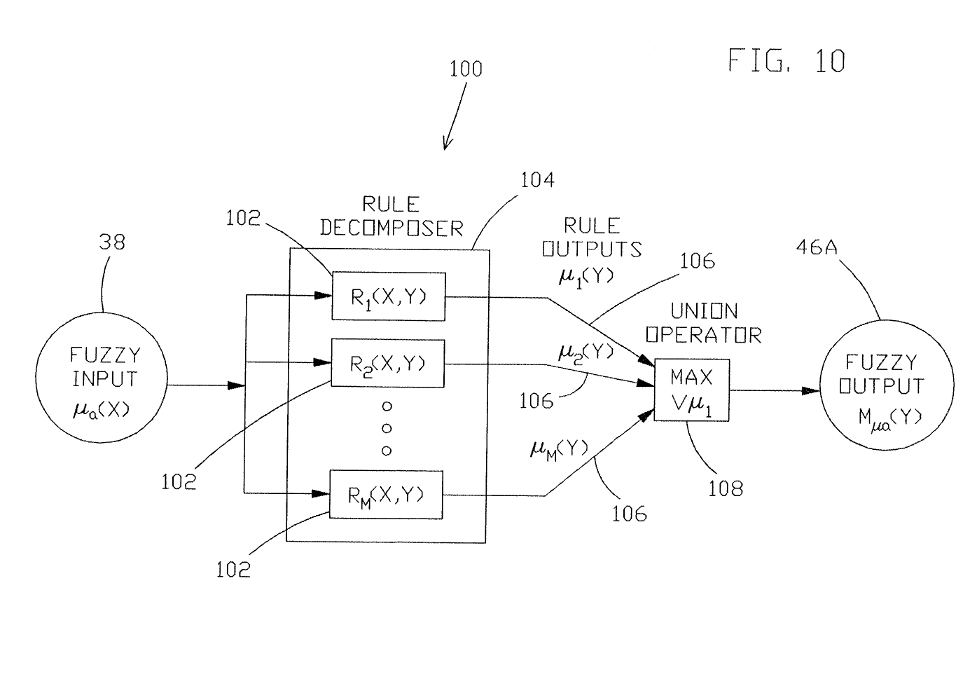

FIGS. 4-9 give a possible example of a step-by-step graphical representation of the process of fuzzy inference system 32 of a type for use in an information and decision system, or for use as a stage in a decision process. Such systems or decision processes are used in naval undersea warfare, for example to provide with a submarine the display depicted in FIG. 9 showing position of an acoustic contact relative to ownship position. Where the information concerning the position of the acoustic contact is uncertain due to uncertain physical phenomenon affecting acoustic signal propagation, the display of FIG. 9 assists the submarine's commander in making combat control decisions in the presence of uncertain physical phenomenon. As will be explained below, the display of FIG. 9 is derived from output 46 of system 32. It will be understood that this example is given for explanatory purposes only. Another example—this time in providing an input to a control system—is the application of output 46 from system 32 as a control system input signal for a homing guidance control system of a self-guided underwater missile to provide ig improved kill capability thereof. The invention is not intended to be limited by these examples and may be used in different applications and conditions, including, but not limited to: medical, industrial, marine, broadly any form of warfare, exploration, and numerous other settings.

Referring now to FIG. 4 and subsequent figures, the axes x, y and z are defined as class axis 66, membership axis 68 and speed axis 74, respectively. The example is based upon a two rule, one input, one output fuzzy inference system, which will provide target speed based upon detected class. The target will have a higher speed if it has a nuclear engine than if it has a diesel engine. Class axis 66 ranges from zero to one, with zero denoting diesel and one representing nuclear. Membership axis 68 also ranges from zero to one, with zero designating no membership and one indicating one hundred percent membership in the specified class. Therefore, a target is diesel if class equals zero and membership equals one, whereas a target is nuclear if class equals one and membership equals one. Speed axis 74 ranges from zero to forty, or the range of speed of the target in knots. A nuclear engine target is more likely to be traveling in the range of 15 to 30 knots as compared with a diesel engine target with a speed more likely in the range of 5 to 15 knots. The rules can be summed up as the following: (1) if class is diesel, then speed is low and (2) if class is nuclear then speed is high, as depicted by the three dimensional rule graph 70 represented by the function F(x,y). The rules for the present example are graphically displayed as a set, map, figure, or curve as shown in FIG. 4. It will be understood that while the map or set of values indicated may be easily visualized in three dimensions as in the example of FIG. 4, other systems of rules, inputs, and/or outputs may use many dimensional or n-dimensional maps that are not so easily visualized.

The example further continues with the fact that sensors and/or other intelligence have detected a target with class equal to about 0.3 with some amount of uncertainty. The sensors used for this purpose might conceivably be sonar intelligence that detects a propeller speed or type of sound or the like. The result of the detected input is graphically depicted in FIG. 5 with an input that is uncertain but has possible values about it point 64, representing x=0.3. For this example, a Gaussian membership function, graph, map or set 72 describes the fuzzy input. The target is not described exactly in class equal to 0.3, but rather is described as a possible value within the area under the curve but uncertain as to exactly what that value is. If the input were definite, such that the information was exactly 0.3, then the present invention would also operate to handle that situation in the same manner as discussed below. Function 72 would then simply be a straight line at 0.3. Thus, the present invention is operable with both definite and uncertain data. However assuming the input to be uncertain, then Gaussian membership function 72, for an example only, may have formula equal to

$${μ}_{0.3} ( x ) = exp [ - \frac{{( x - 0.3 )}^{2}}{2 * {0.05}^{2}} ] \qquad ( 6 )$$

In accord with the system and method of the present invention, Gaussian membership function 72 is extended onto speed axis 74 to make cylindrical extension map, function, set or graph 76 as shown in FIG. 6, depicting the operation of extensor or cylindrical extensor 40. Thus, the input is extended onto at least one dimension characteristic of the rules. Cylindrical extension map, set, function or graph 76, represented by μ_{0.3}(x,y), is obtained by the mathematical expression discussed above, i.e.,

μ_{0.3}(x,y)=μ_{0.3}(x)∀y. (7)

Fuzzy mapping section 42 operates on cylindrical extension map, set, or graph 76 and rule map, set, or graph 70. In the present example an intersection is found as the result of this operation that provides map, set, or conditioned surface graph 78 as shown in FIG. 7. Conditioned surface map, set or graph 78, noted as F_{c}(x,y), was obtained in accord with the equation expressed above, i.e.,

F_{c}(x,y)=min[F(x,y), μ(x,y)]. (8)

In FIG. 8, conditioned surface graph 78 is fed into the retro-projector where the graph is projected onto speed axis 74 and possibility axis 84. A dimension is deleted in accord with the desired output terms resulting in two dimensional output fuzzy data 80. Interpretation of this graph states that the target is more likely to be traveling about ten knots, but still has the possibility of going about twenty to thirty knots, though this is not as likely. Line 82 is the graph obtained had exact values been taken with x=0.3, resulting in the uncertainty obtained using fuzzy input being deleted and never taken into account. Had this been done, as would have been a plausible solution for prior art fuzzy logic inference systems that require an exact input, then the likelihood would have been significantly greater that the speed is in the range of about ten knots. Thus, a decision maker might have been more likely to make a decision that committed too early to the decision, implicitly basing the decision upon an assumption that the target speed is in the range of about ten knots. A better decision would have been to wait as long as possible before committing due to the increased possibility that the speed was in the range of from fifteen to thirty knots when the uncertainty of the input was included in the calculation.

In a bearings-only target motion analysis problem it is necessary to estimate contact location and motion parameters using a time series of bearing measurements. A fundamental problem of the bearings-only target motion analysis application is that the contact range is not observable for a single-leg of ownship motion wherein a leg is defined as a time interval of a constant platform, such as a ship or submarine, velocity. A time lag is therefore introduced into the estimation process owing to the necessity of collecting sufficient data on all legs of motion. In some cases rapid estimates are needed even though they may be of poorer quality due to the time delay. Tactical map 86, shown in FIG. 9, is one possible resulting use of the data obtain about the target. The fuzzy characterization of contact speed as discussed above using the fuzzy logic inference system output as shown in FIG. 8 to produce an enhanced area of uncertainty description for the single leg target motion analysis. Tactical map 86 shows in Kyards the target's suspected contact end-point position 96 in relation to observer 94. Tactical map 86 also displays area 88, depicted 50% possibility of the target end point being in that area. Area 90 depicts 85% confidence, and area 92 denotes 98% confidence of the target being within those borders. For reference, location 98 is the actual target end point position. While end-points of the likely tracks are displayed in tactical map 86, the various possible tracks with the most likely track may also be viewed with a colored weighting for the likelihood of the various tracks.

The computation of the fuzzy nonlinear mapping F(x,y) as discussed hereinbefore is very numerically intensive, and is a function of the number of inputs and the grid-resolution employed. For instance, the 2-input fuzzy inference system characterizing contact speed takes approximately 45 minutes to compute on a Pentium 100 MHz PC system (with grid-size 100). Since this mapping is fixed for a given fuzzy system, it is precomputed off-line and stored prior to actual usage of the fuzzy inference system. A vectorized approach to the fuzzy composition algorithm was devised using the MATLAB computing environment. The resultant system is found to evaluate the fuzzy output in about 10 seconds, thus achieving significant speed-up and realistic computing times.

However, memory storage requirements for the fuzzy inference system mapping F(x,y) increase significantly with the number of inputs. The scale-up in dynamic RAM storage required at run-time as the fuzzy system dimension, defined as number of inputs, increases quickly as the number of inputs or dimensions increases. For instance, if a one dimensional or one input system requires 80 KBytes of RAM storage, a two dimensional system may require 8 MBytes of RAM storage, and a three dimensional system may require 800 MBytes of RAM storage.

This poses severe limitations on the utility of the fuzzy composition method in a real-time system application, and is impractical for fuzzy systems of dimension 3 or greater. In accordance with the present invention, an efficient computational method for propagation of uncertain inputs through the fuzzy inference system is based on the principle of Rule Decomposition, as presently will be described.

Referring now to FIG. 10, a preferred embodiment of the present invention is disclosed. FIG. 10 provides a block diagram of fuzzy system 100 that provides an efficient ti; architecture for propagation of uncertain inputs through a fuzzy system. In fuzzy system 100 of FIG. 10, the fuzzy mapping F(x,y) derives from a knowledge-base of M rules. In a preferred embodiment of the present invention, the fuzzy mapping 46A is expressed as the conjunction of rule outputs or mappings 106 from union operator 108 of each individual rule 102 whereby rule decomposer 104 comprises a plurality of individual rules 102 as described in more detail subsequently. Mathematically stated:

F(x,y)≡R₁(x,y)∪R₂(x,y)∪ . . . R_{M}(x,y). (9)

Let the 1 th rule be denoted by Rₗ(x,y);l=1,2, . . . M. Hence, the fuzzy inference system output fuzzy set is:

$${M}_{{μ}_{a}} ( y ) = F ( x , y ) ∘ {μ}_{a} ( x ) = {{⋃}_{l = 1}}^{M} {R}_{l} ( x , y ) ∘ {μ}_{a} ( x ) . \qquad ( 10 )$$

Define fuzzy set μₗ(y) as the output response 106 of a rule 102 such as the rule Rₗ(x,y) to an input 38 such as fuzzy input μₐ(x). Then

$${μ}_{l} ( y ) = {R}_{l} ( x , y ) ∘ {μ}_{a} ( x ) = {S}_{{∀}_{x}} [ T ( {R}_{l} ( x , y ) {μ}_{C} ( x , y ) ) ] . \qquad ( 11 )$$

Each rule 102 such as rule Rₗ(x,y) may define a fuzzy relation of the form IF (x is F) THEN (y is G) and may be denoted as

Rₗ(x,y)=T(μ_{F}(x),μ_{G}(y)) (12)

Substituting and simplifying Eq. (12) into Eq. (11) as follows leads to an expression for output response 106 of the 1 th rule:

$${μ}_{l} ( y ) = T ( {μ}_{G} ( y ) , {S}_{∀ x} [ T ( {μ}_{F} ( x ) , {μ}_{a} ( x ) ) ] ) \qquad ( 13 )$$

For min-max implementation of the T- and S-norms, the Eq. (13) can be reduced to

$${M}_{{μ}_{a}} ( y ) = {{⋃}_{l = 1}}^{M} {μ}_{l} ( y ) \qquad ( 15 )$$

Finally, the fuzzy inference system output fuzzy set from Eq. (10) is determined via the union operation determining a conjunction of the plurality of individual rules, and is given by

$${μ}_{l} ( y ) = min ( {μ}_{G} ( y ) , {μ}_{H} ( {x}_{sup} ) ) , where \\ {μ}_{H} ( {x}_{sup} ) = {max}_{∀ x} min ( {μ}_{F} ( x ) , {μ}_{a} ( x ) ) \qquad ( 14 )$$

whereby union operator 108 produces the above described output.

In essence, the method of the present invention utilizes Rule Decomposition as a divide-and-conquer strategy that reduces a large computational problem to several tractable sub-problems. If n=system-dimension (number of inputs), then the fuzzy composition R₁(x,y) is in general over the n-dimension space X₁×X₂× . . . Xₙ. The rule decomposition of Eq. (10) has the effect of reducing this n-dimensional problem to n 1-dimensional sub-problems for each rule. Hence, the Rule Decomposition method requires the equivalent of solving M×n 1-dimensional sub-problems. In this way, the present invention provides computation efficiency.

Moreover, if N=grid-dimension, it can be shown that the number of full operations (flops) required for Rule Decomposition and Fuzzy Composition are:

flops(RD)=[2(n+1)M−1]*N, and (16)

flops(FC)=2Nⁿ⁺¹. (17)

Therefore, a plot of computational cost versus system dimension would show that while the computational cost for the Fuzzy Composition system 10 as discussed hereinbefore grows exponentially with system dimension, the method of the present invention utilizing Rule Decomposition techniques increases only linearly and is hence the improved method of choice.

Another significant advantage of the method of the present invention utilizing Rule Decomposition relates to the nominal requirement on dynamic memory storage at run-time. At any given time, the memory used is that employed in solving a 1-dimensional sub-problem, together with the associated book-keeping overhead. Computer simulation experiments show that this memory usage has very little impact on system performance and is well within typical PC-application requirements.

It will be understood that many additional changes in the details, materials, steps and arrangement of parts, which have been herein described and illustrated in order to explain the nature of the invention, may be made by those skilled in the art within the principle and scope of the invention as expressed in the appended claims.

What is claimed is:

1. A fuzzy inference system for processing information from a plurality of inputs that are associated with one or more physical phenomena, said plurality of inputs being described as an input set including a plurality of possible values wherein at least one or more of said plurality of inputs has uncertainty as to which of said plurality of possible values is the actual value of said at least one or more inputs, said fuzzy inference system comprising:
a rule decomposer comprising a plurality of rules, each of said rules being utilized for producing an output in response to said plurality of inputs to thereby produce a plurality of rule decomposer outputs; and
a union operator for determining a conjunction of said plurality of rule decomposer outputs to produce a fuzzy inference output.

2. The system of claim 1 wherein said each of said plurality of rules has an IF-THEN format.

3. The system of claim 1 wherein said fuzzy inference system for processing information is of utility in processing an input to a control system, the fuzzy inference system further comprising:
said fuzzy inference output of said fuzzy inference system being applied as an input to a control system.

4. The system of claim 3 wherein said fuzzy inference system for processing information is of special utility in processing an input to an intercept guidance control system for an undersea self-guided missile, the fuzzy inference system further comprising:
said fuzzy inference output being applied to said intercept guidance control system to improve performance in presence of the physical phenomena.

5. The system of claim 1 further comprising:
a dynamic RAM storage utilized for storing precomputed rule decomposer outputs.

6. The system of claim 5 wherein said union operator is described mathematically by an equation of the form:
$${M}_{{μ}_{a}} ( y ) = {{⋃}_{l = 1}}^{M} {μ}_{l} ( y ) .$$

7. A fuzzy logic method for utilizing uncertain input data that has an uncertain value contained within an input set of possible values, said uncertain input data being associated with one or more physical phenomena, said method comprising the steps of:
providing a plurality of fuzzy inference rules;
producing a plurality of rule outputs in response to said uncertain input data; and
inferring a fuzzy inference by determining a conjunction of said plurality of rule outputs.

8. The method of claim 7 further comprising:
operating on said input set of possible values to produce a rule output for each of said plurality of rules.

9. The method of claim 7 further comprising:
precalculating said plurality of rule outputs.

10. The method of claim 9 further comprising:
storing a result of said step of precalculating in RAM memory.

11. The method of claim 7 wherein said fuzzy logic method for processing information is of special utility in assisting a military commander in making combat control decisions, the fuzzy logic method further comprising the step of:
producing a tactical picture that incorporates said output from said fuzzy inference system.

12. The method of claim 7 wherein said conjunction is determined mathematically by utilizing an equation of the form:
$${M}_{{μ}_{a}} ( y ) = {{⋃}_{l = 1}}^{M} {μ}_{l} ( y ) .$$

13. A method for a fuzzy inference system for utilizing uncertain input data that has an uncertain value contained within an input set of possible values, said uncertain input data being associated with one or more physical phenomena, said method comprising the steps of:
producing a plurality of one dimensional solutions in response to said uncertain input data; and
inferring a fuzzy inference output by determining a conjunction of said one-dimensional solutions.

14. The method of claim 13 wherein said fuzzy logic method for utilizing uncertain input data is of special utility in assisting a military commander in making combat control decisions, the fuzzy logic method further comprising the step of generating from said fuzzy inference output a tactical picture display which represents uncertainty associated with the physical phenomena.

15. The method of claim 13 further comprising:
producing said plurality of one-dimensional solutions from a plurality of rules.

16. The method of claim 15 further comprising:
producing a respective one-dimensional solution from a respective rule.

17. The method of claim 14 further comprising:
the tactical picture display generated from said fuzzy inference output further depicting a range of possibilities for the military commander to chose among.

18. The method of claim 13 wherein said step of determining a conjunction of said one dimensional solutions is described by a mathematical equation of the form:
$${M}_{{μ}_{a}} ( y ) = {{⋃}_{l = 1}}^{M} {μ}_{l} ( y ) .$$
